(19) United States
(12) Patent Application Publication
(10) Pub. No.: US 2008/0054020 A1
(43) Pub. Date: Mar. 6, 2008

(54) Aerosol delivery system for dispensing dental compositions

(76) Inventors: Paul R. Pierson, Camden, DE (US); Robert V. Hare, Georgetown, DE (US)

Correspondence Address: DENTSPLY INTERNATIONAL INC, 570 WEST COLLEGE AVENUE, YORK, PA, 17404, US

(21) Appl. No.: 11/801,831

(22) Filed: May 11, 2007

Related U.S. Application Data
(60) Provisional application No. 60/799,481, filed on May 11, 2006.

(51) Int. Cl. B67D 5/52; B67D 5/60; G01F 11/00

(52) U.S. Cl. 222/135; 222/145.6; 222/389

(57) ABSTRACT

An aerosol delivery system for dispensing a multi-component dental composition is provided. The system is particularly suitable for dispensing dental impression material containing mixed components A and B. The system includes a dispensing device having an inner container with pressurized aerosol chambers. The first chamber is used for storing and dispensing component A, and the second chamber is used for storing and dispensing component B. The dispensing device includes a piston assembly having a first piston member that slides within the first chamber and a second piston member that slides within the second chamber. The pistons force the components into a common manifold, and the combined material is fed into a dispensing tip containing a static mixer, wherein the material is mixed and then dispensed.

### CROSS-REFERENCE TO RELATED APPLICATIONS

This application claims the benefit of U.S. Provisional Patent Application Ser. No. 60/799,481 having a filing date of May 11, 2006, the entire contents of which are hereby incorporated by reference.

### BACKGROUND OF THE INVENTION

1. Field of the Invention

The present invention relates generally to an aerosol delivery system for dispensing multi-component dental compositions. Preferably, the dental composition is a dental impression material comprising first and second components. The delivery system includes aerosol containers for storing and dispensing the components of the composition. A dispensing tip containing a static-mixing element is used in the system for mixing the components and delivering the mixed product.

2. Brief Description of the Related Art

Dental professionals use dispensing devices for storing, mixing, and dispensing a wide variety of dental compositions. For instance, a dentist may use a dispensing device in preparing and dispensing dental impression materials; restoratives such as crowns, bridges, veneers, and fillings; dental cements and adhesives; and other dental materials. Such dental compositions can be self-curable, light-curable, heat-curable, or dual-curable. The dental compositions are cured and hardened by different chemical mechanisms to form a strong and durable product.

For example, a dental professional will use a dispensing device to inject an impression material into a bite tray. The dentist inserts the filled tray into a patient's mouth, and the patient bites down on the impression material in the tray. The tray material is allowed to cure and harden to form a negative impression of the patient's teeth and surrounding gum tissue. Then, the resulting solid impression can be sent to a dental laboratory, where a technician may pour dental plaster into the impression to produce a dental model (cast). This model can be used to make inlays, crowns and bridges, removable prosthetic devices, and various other dental products.

The dental composition used for taking the impressions is often prepared from two paste components. One component used to make the impression material is a base paste and the other component is a catalyst paste. At least one of the paste components contains an elastomeric material such as vinyl terminated polysiloxanes capable of undergoing addition polymerization. Once the pastes are mixed together, they start to harden and form a rubbery impression material. The base and catalyst components are stored in commercially-available cartridges and dispensed in a pre-determined volume ratio to form an optimally mixed composition. With such auto-mix systems, the dentist can save time and avoid mixing ratio errors.

A double-barrel, syringe-like dispensing device is often used in auto-mix systems. The double barrel syringe includes two separate, elongated barrels or chambers that are arranged side-by-side. The barrels are sealed, and the base paste is stored in one barrel, while the catalyst paste is stored in the other barrel. The barrels are connected to a dispensing tip. In practice, the dentist pushes on a plunger to force the base and catalyst materials from their respective barrels and into the dispensing tip. The dispensing tip typically contains a static mixer. As the base and catalyst pastes are extruded through the static mixer, they are combined and mixed together to form the final, mixed impression material. The dentist then dispenses the resulting impression material into a bite tray for taking the impression.

One example of a double barrel dispensing syringe is illustrated in Drake, U.S. Pat. No. 4,538,920. The '920 Patent discloses a dispensing device having a having a pair of chambers for storing dental resins separately and a pair of plungers that are forced into the chambers to discharge the resins. The device further includes a static-mixing element housed within a discharge nozzle. The dental resins are combined and mixed together as they are extruded through the discharge nozzle.

Other dual chamber systems for dispensing dental material are known including hand-held ejector-type guns as described in Wilcox et al., U.S. Pat. Nos. 5,624,260 and 5,722,829. These gun-like applicators include a cartridge having a first chamber and a second chamber for storing different dental compositions and a pair of plungers for dispensing the compositions through a discharge tip. The applicator further includes a handle extending from a body portion and an arm located next to the handle and movable relative to the body. To advance the plungers, the arm is swung about the pivot point. As the arm moves toward the handle, the lower front edge of a pawl engages the ratchet teeth on the plungers, there causing the plungers to simultaneously advance. These applicator guns can provide an effective system for dispensing highly viscous resinous materials. The applicator guns increase the mechanical advantage of the operator. This allows the operator to hold the gun in various orientations and dispense the material in difficult to reach areas of a patient's oral cavity. However, such applicator guns have several disadvantages including their added bulk, complexity of operation, and relatively high cost to manufacture.

In view of some drawbacks with some conventional dental dispensing devices, there have been efforts in the industry to develop improved systems. One promising new delivery system uses aerosol containers. The dental composition is stored under pressure in the aerosol container. When the composition is ready to be used, it is ejected from the container by means of a gaseous propellant. The device may be outfitted with a discharge nozzle for delivering the composition to a selected target.

Aerosol dispensing systems are generally known and used in a variety of industries. For example, O'Neill, U.S. Pat. No. 3,273,762 discloses a pressurized aerosol container including a piston that is used to isolate the propellant from the product to be dispensed. The aerosol can is described as being useful for dispensing foodstuffs and paints. An aerosol container using such a piston is known in the industry as a barrier package because the piston provides a barrier between the product and propellant.

In the dispensing device described in Safianoff, U.S. Pat. No. 3,575,319, two aerosol containers, each storing a separate pressurized component, are mounted to a supporting frame. Each container includes a valve and the valves can be activated simultaneously by a trigger on the supporting frame. The components are discharged from their respective containers and fed to a mixing chamber. The mixed composition is then discharged through an exit port. The dispenser is described as being particularly suitable for dispensing polyurethane foam reaction mixtures.

Moddemo, U.S. Pat. No. 3,818,484 discloses a dispensing device in which two different materials are stored in separate containers respectively. The dispensing device is pressurized with a gaseous propellant. A first material is stored in an outer container and a second material is stored in an inner container, which is positioned axially within the outer container. The inner container is friction-locked to a cap and this keeps the first and second materials separated from each other. In order to mix the materials together, the user presses on the nozzle. This causes the inner container to become detached from the cap allowing the materials to mix with each other. The '484 Patent contemplates that many different materials can be packaged in the device including hair dyes, dental impression formulae, polyurethanes, rubberized silicones, epoxies, polystyrene foam, foods, insecticides, lacquers, and paint compositions. But, the '484 Patent describes neither how to make nor how to use such materials in the dispensing device. There is no description of the composition or formulation of such materials. Furthermore, the '484 Patent does not describe an aerosol barrier system wherein the propellant is isolated from the dispensed product.

Miczka, U.S. Pat. No. 4,801,046 discloses a device having two separate containers for storing and dispensing pressurized flowable components. The metal device houses two smaller plastic containers having an accordion-like pleated structure, which are supported in common on a piston. A gas propellant causes the piston to act on the containers and the components are delivered to a mixing chamber in the adapter head. Supply lines are included in the adapter head for delivering the components to the mixing chamber. Dosing sleeves may be included in the supply lines making it possible to modify the ratio of the components to a certain extent. The dispenser is described as being particularly suitable for dispensing pressurized flowable components. The Miczka patent discloses D-shaped collapsible compartments, but they are distinct and separate from the piston. The Miczka device is not preferred because air bubbles can accumulate in the pleated folds of the collapsible containers during filling.

Mears, U.S. Pat. No. 6,168,335 discloses a device having an applicator head mounted to multiple aerosol containers containing components under pressure. The applicator head includes a mixing chamber for mixing the components that are dispensed from the aerosol containers. The resulting mixed product is discharged through multiple outlet ports. The adapter has a comb-like structure comprising multiple solid and hollow teeth (tines). A user holds the adapter in the same manner as he or she would hold a hair comb or brush. The mixed product is discharged from the outlet ports of the hollow tines onto a person's hair, while the longer tines are used to penetrate through the hair and spread the product. The device is described as being particularly suitable for dispensing shampoos, conditioners, styling gels, hair dye, and other hair treatment products.

Green, U.S. Pat. No. 6,736,288 discloses an aerosol container having a multi-valve body. A single actuator activates the valves. A first material is stored in a first collapsible bag-on-valve compartment, and a second material is stored in a second collapsible bag-on-valve compartment. Pressurized gas is injected into the container in the area surrounding the bags. When the actuator is depressed, the proper amount of material in each bag is driven out of the bag by the pressurized gas. The '288 Patent describes the aerosol system as being generally useful for dispensing resins, sealing compounds, dental compositions, adhesives, paints, hair coloring agents and other chemical components, but provides no detail as to the composition or formulation of dental materials.

In addition, it is know that non-aerosol dispensing devices can be used to dispense two fluid materials simultaneously prior to mixing the materials in many industries. For example, Anderson, U.S. Pat. No. 4,366,919 discloses a coaxial cartridge comprising an inner cylindrical chamber and an outer annular chamber. The cartridge may be used to dispense an epoxy resin. Part A of the composition (for example, an epichlorohydrinlbisphenol A type resin) may be stored in the inner chamber and Part B (the catalyst) may be stored in the outer annular chamber. The inner chamber has a circular piston and the outer chamber has a donut-shaped annular piston. The pistons are separate and distinct and are driven by a secondary plunger mechanism.

Although some of the foregoing aerosol delivery systems may be effective in mixing and dispensing non-dental compositions, these systems are not feasible for delivering dental compositions. Multi-component, paste-like dental compositions present particularly difficult challenges. Each paste component of the composition must be able to flow through the aerosol system smoothly and uniformly. The mixed paste components must be either thick enough or exhibit thixotropic behavior so that the mixed composition can be used for its intended purpose, for example, making impressions or restoratives. The dentist must be able to work with and handle the mixed composition. That is, the composition must have good working and setting times. At the same time, the viscosity of the individual paste components prior to mixing must be either sufficiently low or the paste components must have thixotropic characteristics so that they can be ejected from the aerosol containers. The rheology characteristics of the paste components should allow the components to be dispensed from the aerosol containers evenly so that they can be uniformly mixed together. The aerosol containers must function in such a manner so as to provide simultaneous and synchronous displacement of the components.

The present invention provides an aerosol delivery system having these features and characteristics. The dispensing device is suitable for delivering multi-component dental compositions. These and other objects, benefits, and advantages of this invention are evident from the following description and illustrated embodiments.

### SUMMARY OF THE INVENTION

The present invention relates to an aerosol delivery system suitable for dispensing a multi-component dental composition. The system includes a dispensing device having an inner container with first and second aerosol pressurized chambers. The first aerosol chamber is used for storing and ejecting a first component (A) of the composition, and the second aerosol chamber is used for storing and ejecting a second component (B). The dispensing device further includes a piston assembly having a first inner piston member for sliding within the first chamber and a second piston member for sliding within the second chamber. A joining member connects the first and second piston members so that the piston assembly slides as an integrated unit. A barrier means separates the components from an aerosol component. An outer container houses the inner container assembly, piston assembly and aerosol propellant.

First and second valve systems provide a means for discharging the components into a common manifold that combines them into a common stream and then feeds the stream into a dispensing tip that preferably contains a static mixer. The aerosol propellant forcefully ejects the components from the first and second chambers and into the common manifold. The mixed composition is thus dispensed.

In one preferred embodiment, the inner container assembly includes a first elongated cylindrically-shaped chamber for storing one component. A second chamber for storing the second component surrounds the first chamber and is coaxial thereto. BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description in connection with the accompanying drawings in which:

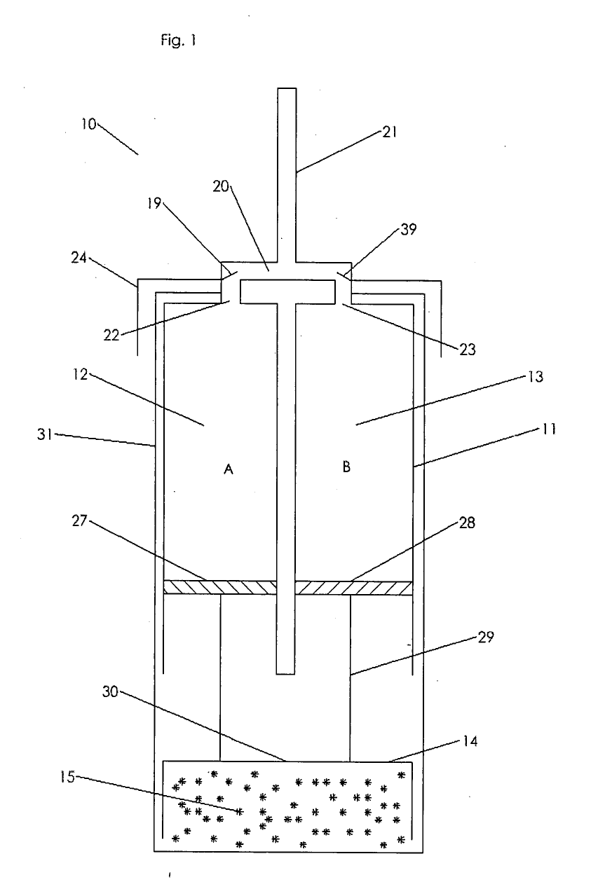

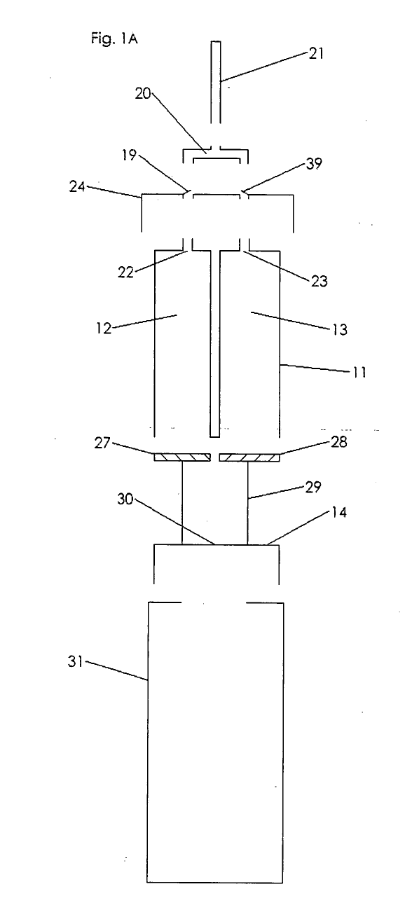

FIG. 1 is a cross-sectional view of one embodiment of the aerosol delivery device of the present invention;

FIG. 1A is an exploded cross-sectional view of the aerosol delivery device shown in FIG. 1;

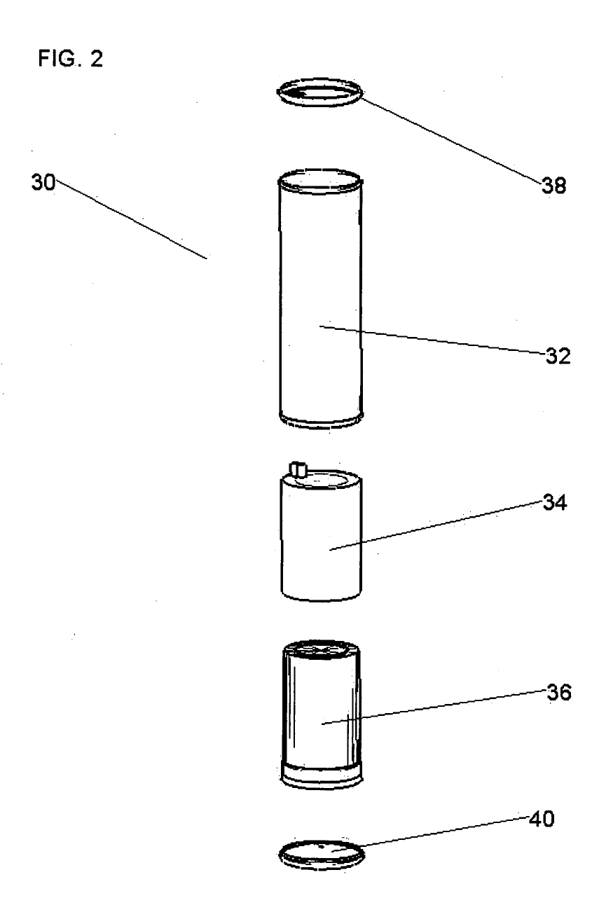

FIG. 2 is an exploded perspective view of another embodiment of the aerosol delivery device of the present invention showing the device with an outer container, coaxial inner container; and piston assembly.

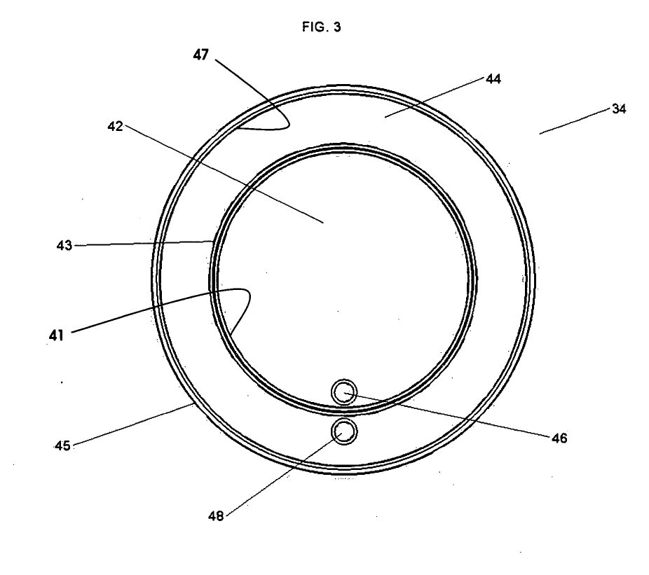

FIG. 3 is a bottom end view of the coaxial inner container shown in FIG. 2;

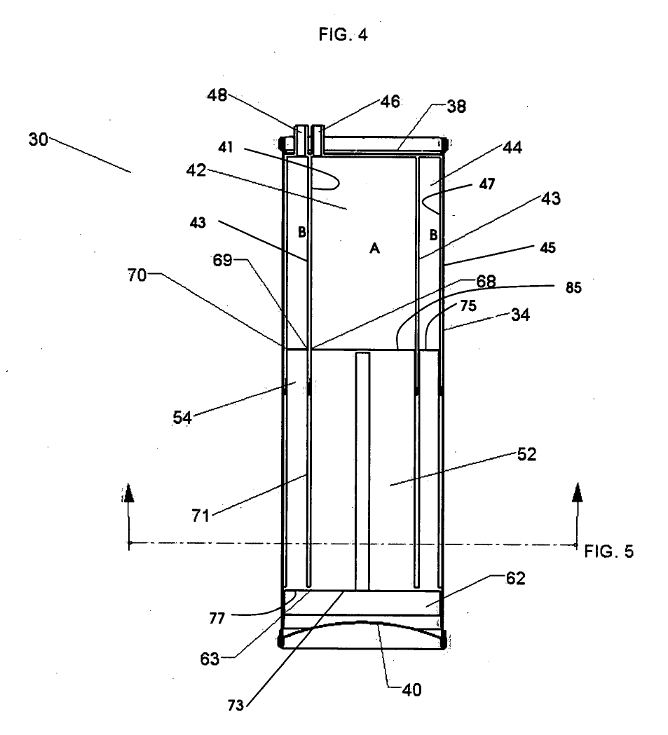

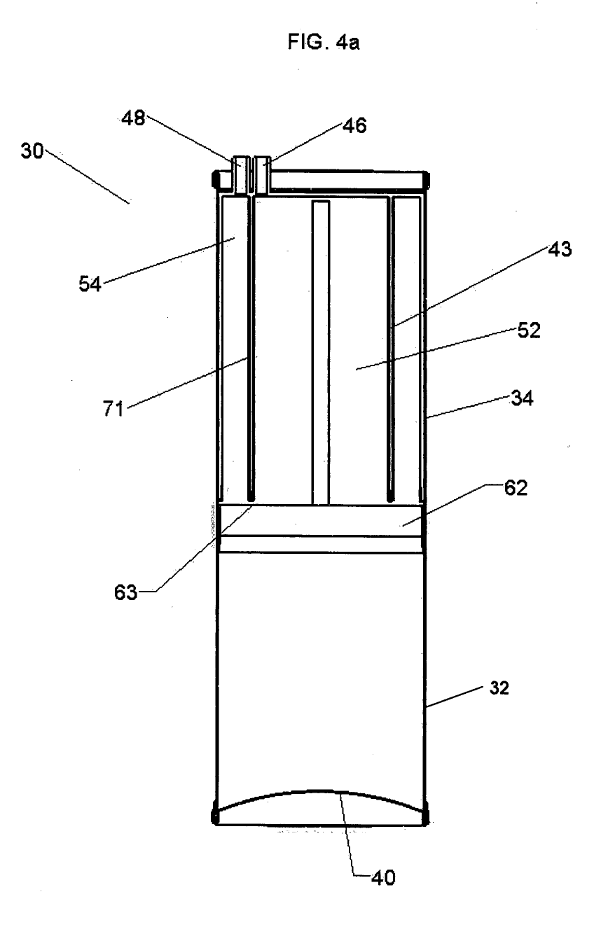

FIG. 4 is a cross-sectional view of the coaxial inner container shown in FIG. 2, wherein the first and second chambers in the container are filled with components (A, B) of the dental composition;

FIG. 4A is a cross-sectional view of the coaxial inner container shown in FIG. 2, wherein the first and second chambers in the container have been emptied of the components (A, B) of the dental composition;

FIG. 5 is a cross-sectional view of the piston assembly shown in FIG. 2;

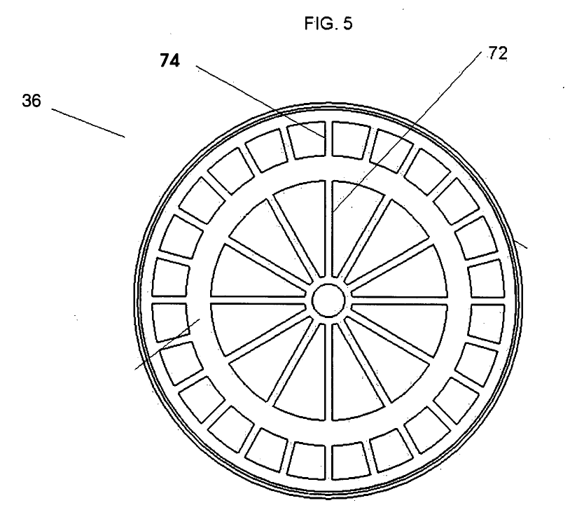

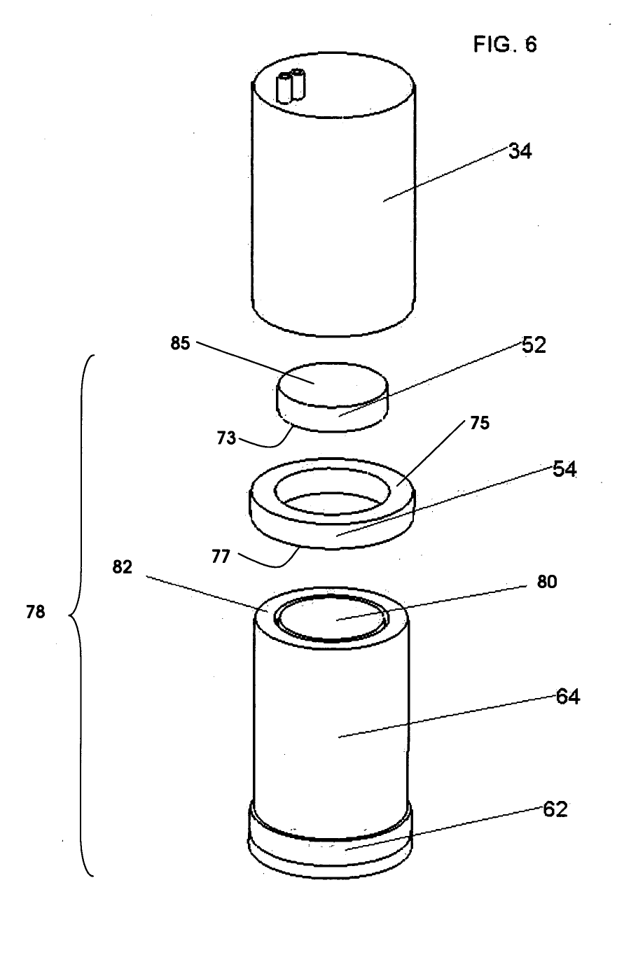

FIG. 6 is an exploded perspective view of another embodiment of the aerosol delivery device of the present invention showing a coaxial inner container and piston assembly having a disc-shaped inner piston and donut-shaped outer piston;

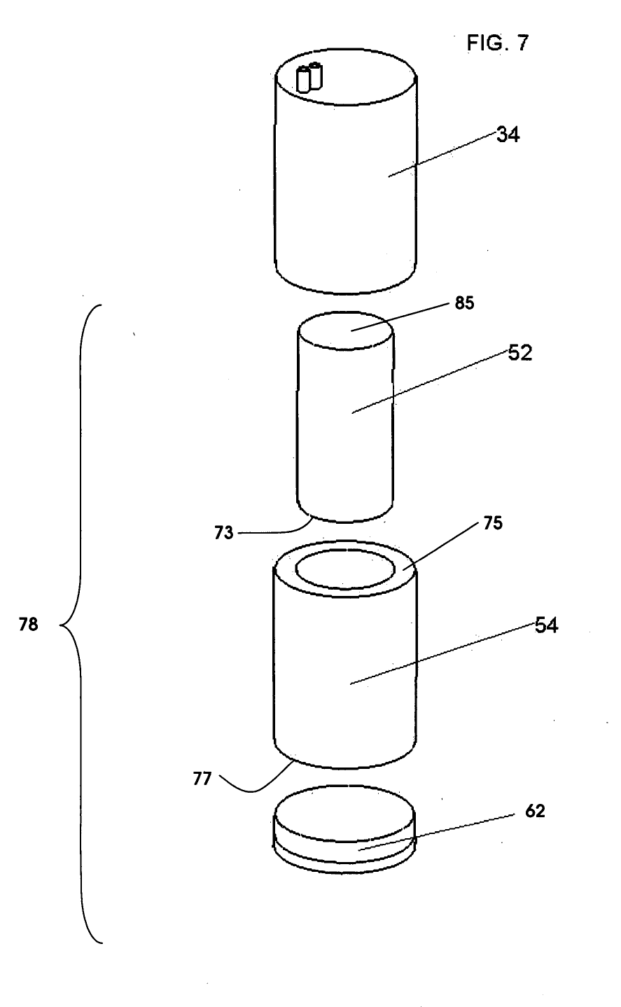

FIG. 7 is an exploded perspective view of another embodiment of the aerosol delivery device of the present invention showing a coaxial inner container and piston assembly having an elongated inner piston and elongated donut-shaped outer piston;

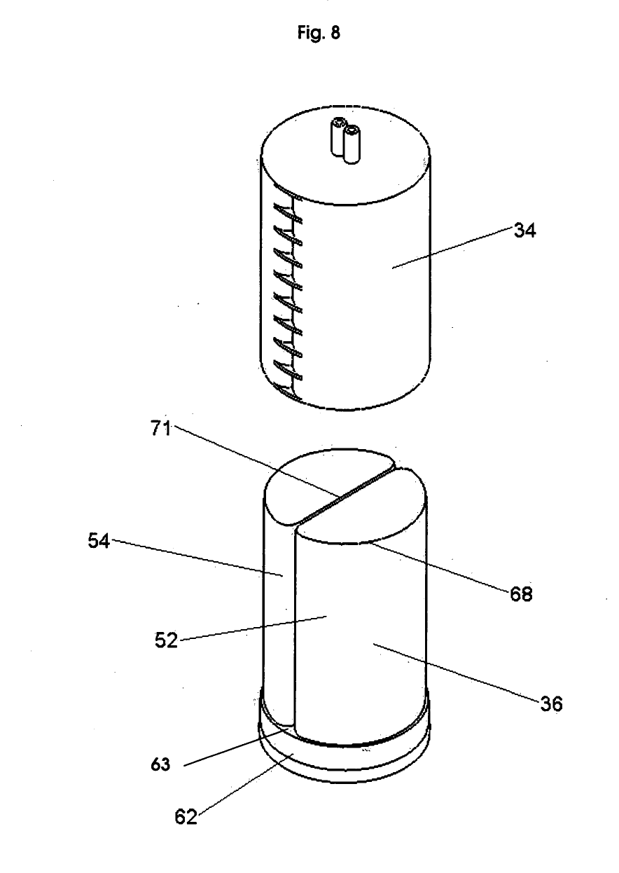

FIG. 8 is an exploded perspective view of another embodiment of the aerosol delivery device of the present invention showing a inner container having first and second chambers that are semi-circular shaped;

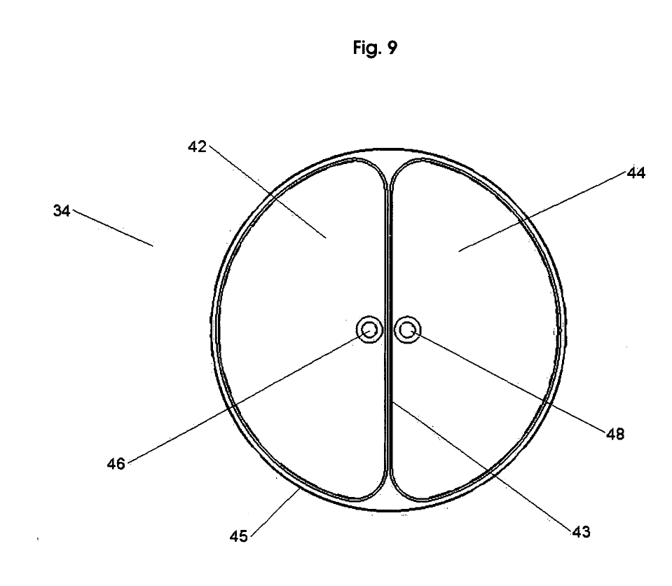

FIG. 9 is a bottom end view of the inner container of FIG. 8 showing the exit ports;

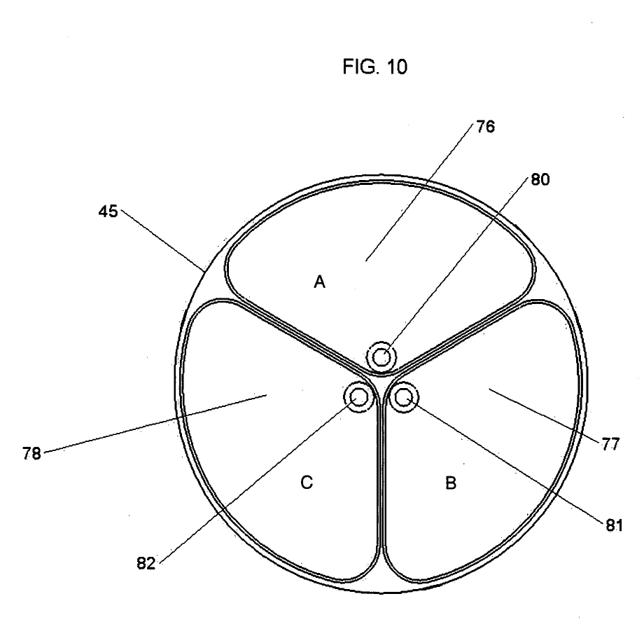

FIG. 10 is another embodiment of a inner container for the aerosol delivery device of the present invention showing a bottom-end view of the inner container having three chambers;

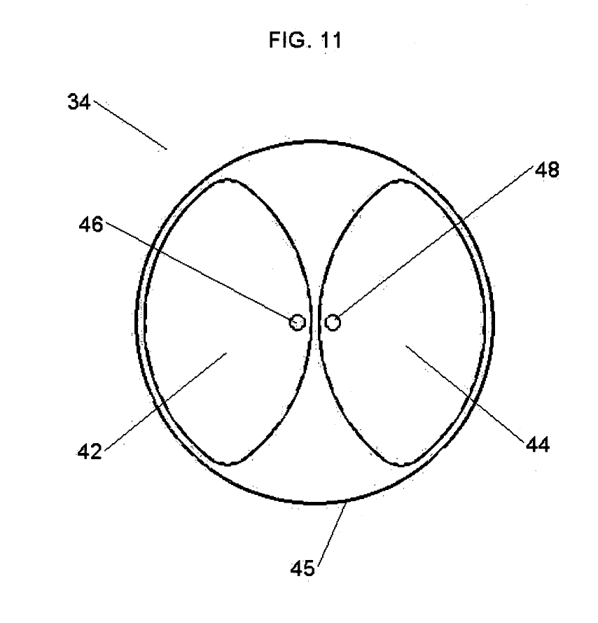

FIG. 11 is another embodiment of a inner container for the aerosol delivery device of the present invention showing a bottom-end view of the inner container having two oval-shaped chambers; and

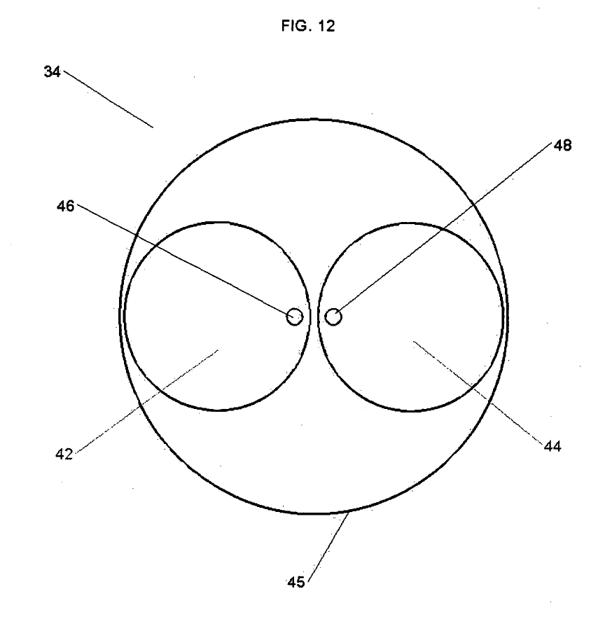

FIG. 12 is another embodiment of a inner container for the aerosol delivery device of the present invention showing a bottom-end view of the inner container having two cylindrically-shaped chambers.

### DETAILED DESCRIPTION OF THE PREFERRED EMBODIMENTS

The present invention relates generally to a dispensing device having first and second aerosol containers. The first aerosol container is used for storing and ejecting a first component of the composition, and the second aerosol container is used for storing and ejecting a second component. By the term, “aerosol container” as used herein it is meant any type of receptacle that holds its components under pressure and ejects them by means of a propellant including, but not limited to, rigid and semi-rigid cans, bottles, vials, chambers, compartments, collapsible bags, and the like. The containers may be made from metal, plastic, or other suitable material. The aerosol container may include multiple compartments or chambers, wherein one or more compartments store the components of the composition and a separate compartment stores a propellant for ejecting the components. In the present invention, it is preferred that the aerosol container be configured in such a way that the propellant is isolated from the components of the composition. In other words, the propellant is not an ingredient of the composition. The piston assembly in the device may include a barrier system that keeps the composition isolated from the propellant.

Although the dispensing device is described primarily herein as including two aerosol containers, it should be understood that the device may be constructed to include any suitable number of aerosol containers. For example, if there is a need to make a three-component dental composition, the device can be outfitted with three aerosol containers, each container holding and storing one component of the composition. A device having two aerosol containers is described herein for illustrative purposes only and this should not be considered restrictive.

The dispensing device may include a dispensing tip for receiving the first and second components as they are ejected from the first and second containers respectively. The dispensing tip may be outfitted with a static-mixing element that combines and mixes the components together. The resulting mixed composition is dispensed through a distal opening in the dispensing tip and onto the selected target.

Referring to FIGS. 1 and 1A, one embodiment of the dispensing device (10) of this invention is shown. The device (10) includes an inner container (11) having first and second compartments or chambers (12, 13), which are used for storing the first and second paste-like components (A, B) of the composition, respectively. The first and second chambers (12, 13) are pressurized with aerosol propellant (15). An inner dividing wall separates the storage chambers (12, 13). First and second valve systems (19, 39) provide a means for releasing components A and B into a common manifold (20) that combines them into a common stream and then feeds the stream into a dispensing tip (21) that preferably contains a static mixer. Upon activating the valve systems (19, 39), components A and B are discharged through exit ports (22, 23) respectively and into the manifold (20). Opening and closing the valve systems (19, 39) provides a means for stopping and starting the flow of components (A, B) into the manifold (20) as described in further detail below.

Product components (A, B) are specially formulated to have either a thinner viscosity or thixotropic properties which are needed to enable the components to be mixed together and allow the resulting mixed composition to flow fast enough to become a commercially viable product. For example, with regards to dental impression materials, the flow rate should preferably be greater than 40 mL/min. and less than 150 mL/min.

The dispensing device (10) includes a depressible, button or lever-like actuator (24) for simultaneously activating the first and second valve assemblies (19, 39). When the button or lever is depressed downwardly against the biasing force of the springs (not shown) in the valve assemblies (19, 39), the individual valve members are opened. This brings the highly pressurized contents (A, B) inside of the respective compartments (12, 13) into contact with the outside atmosphere. The propellant (15) behind barrier (14) expands into the gaseous state and forcefully ejects the components (A, B) through the exit ports (22, 23).

A piston assembly (29) comprising a first inner piston member (27) adapted for sliding within the first chamber (12) and a second piston member (28) adapted for sliding within the second chamber (13) is included in the device (10). A joining member (30) connects the first and second piston members (27, 28) so that the piston assembly (29) slides as an integrated unit. The piston assembly further includes the barrier (14) which slides with the piston members (27, 28). In so sliding, the barrier (14) maintains a seal within the inner wall of outer container (31) such that propellant (15) is sufficiently isolated from the components (A, B) throughout the entire dispensing cycle. As the valve members (19, 39) are opened, the first and second components (A, B) are simultaneously discharged from the first and second compartments (12, 13) respectively to the common manifold chamber (20), which feeds the combined stream into the mixtip (21).

Any suitable propellant (15) can be used in the device (10) including, but not limited to, nitrogen, carbon dioxide, and hydrofluorocarbons (HFCs). One such suitable propellant is HFC-134a (Hydrofluorocarbon, CH₂FCF₃). A liquid propellant such as an HFC having a vapor pressure of 70 PSI can be used. The propellant changes from a liquid to a gas when the pressure is less than 70 PSI. The propellant (15) is pumped as liquid under high pressure into a sub-compartment located behind the aerosol barrier (14). The propellant (15) stays in liquid form so long as pressure is maintained. As the valve members (19, 39) are opened, the pressure on the liquid propellant (15) is reduced and it changes into a gas, providing the pressure needed for pushing upon barrier (14) which subsequently pushes components (A, B) through exit ports (22, 23).

The dispensing tip or nozzle (21) is attached to the common manifold chamber (20) so that it may receive the first and second components (A, B) as they are ejected from the first and second chambers (12, 13). The dispensing tip (21) includes a static-mixing element (not shown) which is common in the industry. The components (A, B) are combined and mixed together as they are fed through the static-mixing element. Then, the well-mixed composition may be discharged through the dispensing tip (21). The dispensing device (10) includes an outer container (31) that houses the inner container assembly (11), piston assembly (29), and aerosol propellant (15).

When a user removes his or her finger from the actuator button or lever (24), there is no longer a downward force being applied, and the valve member is closed. The spring forces the valve member upwardly to close the valve. As a result, the pressurized contents (A, B) inside compartments (12, 13) are no longer in contact with the outside atmosphere. When the valve member is in a closed position, the stored components (A, B) inside of compartments (12, 13) are contained within the device and not ejected.

Referring to FIGS. 2-5, another embodiment of the aerosol dispensing device (30) is shown. The device (30) includes an elongated, cylindrically-shaped outer container (32) that houses a coaxial inner container assembly (34) described in further detail below. A piston assembly (36) is adapted to slide within the coaxial container (34) and frictionally seal the container to deliver first and second components (A, B). As used herein, the term “piston” refers to a sliding piece, which seals a container or compartment and moves to displace material that is sealed in the compartment. As used herein, the term “plunger” means a sliding piece, which acts against another body (usually a piston) in the compartment, but does not provide a seal to the compartment. The main outer container member (32) is sealed on a first end with a top cover (38) and sealed on a second end with a bottom cover (40).

FIG. 3 shows a bottom end view of the coaxial container (34). A first elongated, cylindrically-shaped chamber (42) is located in the center of the coaxial inner container (34) along the same axis as the outer container (32). A second elongated chamber (44) surrounds the first chamber (42) and is coaxial thereto. The first chamber (42) is separated from the second chamber (44) by a cylindrically-shaped inner dividing wall having inner and outer wall surfaces (41, 43). The outer wall surface of the of the first cylindrical chamber (42) forms the first inner concentric wall surface (43) of the second chamber (44). The second chamber further includes a cylindrically-shaped outer wall having outer and inner wall surfaces (45, 47). The first chamber (42) stores one component of the composition (A or B), while the second chamber (44) stores the other component (A or B). Inner chamber (42) has an exit port (46) and outer chamber (44) has an exit port (48) for discharging the components (A, B), respectively. Preferably, the exit ports (46, 48) are located next to each other at the delivery end of the coaxial container (34).

Referring to FIG. 4 (which is shown filled with components A and B), the coaxial inner container (34) is fitted with a piston assembly (36). This includes a first disc-shaped piston member (52) having a forward-facing portion (85) for forcing the first component (A) into the first exit port (46) as well as an opposing rear-facing portion (73). The piston assembly also includes a second donut-shaped piston member (54) having a forward-facing portion (75) for forcing the second component (B) into the second exit port (48) as well as an opposing rear-facing portion (77). A joining member (63) connects the first and second piston members (52, 54) so that the piston assembly (36) slides as an integrated unit. The piston assembly further includes a barrier (62) which separates the components (A, B) from the aerosol propellant and slides in unison with the piston members (52, 54).

In practice, the pistons (52, 54) slide along the inner wall surfaces of the chambers (42, 44) in a manner so as to frictionally seal each compartment (42, 44), respectively. The pistons (52, 54) force the first and second components (A, B) through the exit ports (46, 48) by this sliding/sealing mechanism. One piston (52) is disc-shaped (as viewed from the end) and fits within the inner chamber (42). The other piston (54) is donut-shaped (as viewed from the end) and fits within the outer coaxial chamber. The outer coaxial chamber (44) and piston (54) can also be referred to as being in an annular position to the inner chamber (42) and piston (52). Piston (54) has a leading inner edge (69) and an outer leading edge (70), which forms a primary seal with the outer annular chamber (44). Piston (52) has an outer leading edge (68), which forms a primary seal with the inner wall surface of inner chamber (42). Preferably, the pistons (52, 54) are substantially as long as the chambers (42, 44) are deep. A joining member (63) combines the inner and outer pistons (52, 54) into one contiguous part at their rearward ends. The rearward joining member (63) ties the two pistons (52, 54) together so that they slide in unison and maintain the same position relative to each other in axial movement. This structure allows for synchronized displacement of the pistons (52, 54). The pistons (52, 54) move jointly within inner and outer chambers (42, 44) so that the first and second components (A, B) are delivered simultaneously through the exit ports (46, 48).

The integral piston assembly (36) includes a projecting skirt (62) that conforms to and slides along the inner wall surface of the outer container (32). The skirt (62) provides a primary seal between the aerosol propellant stored in the bottom of the outer container (32) and the other system components located on the opposite side of the skirt seal (62). The skirt (62) effectively isolates the aerosol propellant to the rearward end of the container assembly (30).

In practice, for a two-component product, the inner compartment (42) is pre-filled with one component (for example, component A) and the outer compartment (44) is pre-filled with the second component (for example, component B). The inner dividing wall (43) located between the two compartments (42, 44) separates the two components (A, B). As the components (A, B) are being dispensed by movement of the inner and outer pistons (52, 54) the inner dividing wall (43) of the coaxial container (34) fits into the groove (71) located between the inner and outer pistons (52, 54).

Valve assemblies (19, 39), as described above and shown in FIGS. 1 and 1A, with a common manifold is attached to the delivery end of the coaxial inner container assembly (34) so that it may receive the first and second components (A, B) which are discharged through the exit ports (46, 48) respectively. The valve assemblies (19, 39) control the flow of the two components (A, B) and can be opened or closed as necessary to dispense product. The valve assemblies can be opened by a depressible button or lever-like actuator (24) in the same manner as described above. The manifold (20) combines the two components (A, B) into one stream. The combined stream is then channeled through a dispensing tip (21) that contains a mixing element for mixing the components (A, B) together. Conventional dispensing tips known in the industry, such as the mixtip currently used on 50 mL dental material cartridges, may be used on the dispensing device of this invention.

After the two chambers (42, 44) are filled with components (A, B), liquid aerosol propellant such as HFC-134a is pumped into the bottom of the container (30) under high pressure. The bottom of container (30) is then sealed with an elastomeric plug. This is a typical process in the aerosol industry and is known as charging the can.

Referencing FIG. 4a, the coaxial piston assembly (36) slides within the coaxial inner container (34) until all of the material has been mixed and discharged for use. At this point the inner container (34) is in essentially an empty state with only residual material left within.

Referencing FIG. 5, the inner structure of disc-shaped piston (52) has reinforcing structural ribs (72) and the inner structure of donut-shaped outer piston (54) has reinforcing structural ribs (74).

It should be understood that that aerosol dispensing device (30) having coaxial piston assembly (36) with coaxial inner container (34) and surrounding outer container (32) represents only one embodiment of the dispensing device of this invention. The dispensing device may have other structures such as the structures shown in FIG. 6, 7, and 8. The dispensing devices shown in FIGS. 6-12 include many similar components to the device shown in FIGS. 2-5 and like reference numerals are used to identify like components.

Referencing FIG. 6, the device includes a piston and plunger assembly (78) including a disc-shaped inner piston (52) and donut-shaped outer piston (54). The piston and plunger assembly (78) further includes an integral inner plunger (80) for acting upon the rear-facing portion (73) of the inner disc-shaped piston (52), and an integral outer plunger (82) for acting upon the rear-facing portion (77) of the outer donut-shaped piston (54). The plungers (80, 82) and are one contiguous component. With this type of configuration the coaxial container (34) could be filled off-line and assembled as an aerosol dispensing device in a separate operation.

Referencing FIG. 7, another embodiment of the invention has elongated primary pistons (52, 54). These elongated pistons (52, 54) are relatively long in length as opposed to the relative short pistons (52, 54) shown in FIG. 6. The leading edges (85, 75) of primary pistons (52, 54) create a seal within the compartments of coaxial container (34). The elongated pistons (52, 54) are driven forward by the barrier portion (62).

In still another embodiment, the first and second compartments (42, 44) can have any suitable cross-sectional shape for holding and dispensing the components (A, B) of the composition. For example, as shown in FIGS. 8, and 9, the first and second chambers (42, 44) can have D-shaped cross-sectional structures. One benefit with this structure is that the exit ports (46, 48) can be located near the central axis of the entire assembly, making manufacturing, filling and use much easier than with the off-center exit ports. As with the above-described, coaxial structure having cylindrically-shaped compartments, the preferred piston configuration in the device of FIGS. 8 and 9 is one contiguous part having two elongated D-shaped pistons (52, 54) with an integral joining member (63) joining the two pistons at the rearward end. The D-shaped pistons (52, 54), slide within the D-shaped compartments of the coaxial container (34). The skirt (62) seals the inner wall of the outer metal container (32) and provides a barrier between the product components and aerosol propellant.

In another embodiment, the dispensing device could be constructed so that it included more than two wedge-shaped compartments for dispensing products A, B and C. For example, a device having three or more wedge-shaped compartments (76, 77, and 78) for dispensing three or more components through exit ports (80, 81, and 82) could be constructed as shown in FIG. 10. In such a configuration, the components could be in equal or unequal proportions with the proportion being determined by the size of the wedge-shaped compartment.

In FIG. 11, the dispensing device has football-shaped or oval shaped compartments (42, 44). As described above, the mating pistons (52, 54) would have complementary shapes.

In yet another embodiment shown in FIG. 12, the dispensing device has cylindrically-shaped compartments (42, 44). As described above the mating pistons (52, 54) would have complementary shapes.

The above-described aerosol dispensing devices are some examples of systems that may be used in accordance with the present invention. These devices are provided for illustrative purposes only and should not be considered as limiting the scope of the invention. Workers skilled in the art will recognize that many other aerosol dispensing devices may be used to deliver the dental composition of this invention.

In practice, the first aerosol chamber is pre-filled with a first component of the dental composition, and the second aerosol chamber is pre-filled with a second component. Any suitable dental composition may be used in accordance with this invention. For example, two component compositions used to make dental restoratives, filling materials, impression materials, cements, adhesives, sealants, polishes, and the like make be used. Dental compositions used for taking impressions of a patient's dental anatomy are particularly preferred. The dental composition used for taking impressions is prepared from two paste components. One component used to make the dental impression material is a base paste and the other component is a catalyst paste.

Base Paste

The base paste, which is mixed with the catalyst paste to form the dental impression composition, may comprise a blend of polymerizable compound, cross-linking agent, surfactant, and filler materials.

One class of suitable polymerizable compounds is vinylorganopolysiloxanes. These compounds contain vinyl groups capable of undergoing addition polymerization. Preferably, the vinylorganopolysiloxane contains at least about two vinyl groups per molecule. Vinyl terminated polydimethylsiloxanes are particularly preferred. Other vinylorganopolysiloxane compounds having different alkyl, aryl, halogen, and other substituents may be used in accordance with this invention. Also, quadric-functional polysiloxanes, known in the art as QM resins, can be used. The polymerizable compound can be used alone or mixtures of the polymerizable compounds can be used in the base and catalyst pastes. For example, a dispersion of a QM resin having vinyl groups and a vinyl terminated polydimethylsiloxane compound may be prepared.

It should be understood that vinylorganopolysiloxane compounds are only one class of polymerizable compounds that can be used to prepare the dental impression composition of this invention and these compounds are meant to be illustrative and not restrictive of the compounds that can be used. Any elastomeric dental impression material of aqueous or non-aqueous nature can be used. One example of an aqueous impression material is alginate, and examples of non-aqueous materials include polyethers, polysulfides, condensation silicones, polyvinyl siloxanes, and polyurethane methacrylate-type impression materials.

The base paste further includes an organohydrogen-polysiloxane cross-linking agent. Polymethylhydrosiloxane is a particularly preferred cross-linking agent. Other organohydrogen-polysiloxane compounds having different alkyl, aryl, halogen, and other substituents may be used in accordance with this invention.

In addition, the base paste may include a surfactant to improve the wettable nature of the composition. The surfactants help make the composition effective in wetting out the tooth surfaces and surrounding tissue. The surfactant may be of the cationic, anionic, amphoteric, or nonionic type. A key criteria for selecting the surfactant is the surfactant's Hydrophobic Liphophilic Balance (HLB) value (described by Gower, “Handbook of Industrial Surfactants”, 1993). It has been found that the HLB value of the surfactant must be in the range of about 8 to about 11. The higher the HLB value means the more hydrophobic is the substance. In addition, the pH of the surfactant must be in the 6-8 range to prevent side reactions that may be detrimental to polymerization of the impression material. Preferred commercially-available surfactants include IGEPAL CO-530 that is sold by Rhone-Poulenc (Cranbury, N.J.) and contains nonylphenoxypoly(ethyleneoxy) ethanol, and PEG-8 METHICONE, available from BASF.

The base paste also may include non-polymerizable plasticizers to improve the handling and flow properties of the composition. A preferred emulsifying plasticizer is octyl benzyl phthalate. Other plasticizers such as, for example, diethyl phthalate, dibutyl phthalate, and low molecular weight polyglycols also can be used.

Inorganic fillers, which can be naturally-occurring or synthetic, can be added to the base paste. Such materials include, but are not limited to, silica, titanium dioxide, iron oxides, silicon nitrides, glasses such as calcium, lead, lithium, cerium, tin, zirconium, strontium, barium, and aluminum-based glasses, borosilicate glasses, strontium borosilicate, barium silicate, lithium silicate, lithium alumina silicate, kaolin, quartz, and talc. A mixture of silica particles can be used. The mixture may include crystalline silica such as pulverized quartz, amorphous silica such as diatomaceous earth, and silanated fumed silica. Filler particles having different diameter sizes and surface areas can be used to control the viscosity and thixotropicity of the resulting compositions. The filler particles can be surface-treated with a silane compound or other coupling agent to improve bonding between the particles and resin.

The base paste can also include additives to provide the composition with specially desired properties. For example, anti-microbial compounds, fluoride-releasing agents, flavorants, pigments, and the like can be added to the composition

Catalyst Paste

In general, the catalyst paste, comprises a blend of polymerizable compound, catalyst, polymerization inhibitor, and filler materials.

The polymerizable vinylorganopolysiloxanes compounds, which are useful for adding to the base paste, also may be used in the catalyst paste. The catalysts, which are useful for accelerating the addition polymerization reaction between the vinylorganopolysiloxane compounds and the organohydropolysiloxane cross-linking agents are preferably based upon platinum. A platinum compound such as chloroplatinic acid, which is preferably in an admixture or complex with one or more vinyl materials, especially vinyl polysiloxanes, can be used. Other catalysts are also useful including, but not limited to, palladium, rhodium, and other metals along with their respective complexes and salts.

The catalyst or base paste also may include a polymerization inhibitor such as, for example, 1,3 divinyltetramethyldisiloxane. The polymerization inhibitors are initially consumed in the polymerization reaction and this acts to slow down the polymerization reaction of the above-described vinylorganopolysiloxane compounds. Thus, the curing and hardening of the composition are delayed. Since the working and setting times of the composition are extended, the dental practitioner is better able to handle the composition.

A surfactant for improving the wetting properties of the composition, as described above, may be added to the catalyst paste. However, it is preferred that only the base paste contains a surfactant. If the surfactant is added to the catalyst paste, it may react with the platinum-based catalyst leading to polymerization problems with the composition.

The catalyst paste may contain fillers and additives selected from the same group of fillers and additives used in the base paste as described above. The catalyst and base paste may include the same fillers, for example, silanated silica. Alternatively, the catalyst paste may include different filler materials.

In addition, the composition may include a chemical system for diminishing the presence or degree of hydrogen outgassing that may occur as a result of the vinyl polymerization. Particularly, the composition may comprise a finely divided platinum metal that scavenges for and takes up such hydrogen. The Pt metal may be deposited upon a substantially insoluble salt having a surface area of between about 0.1 and about 40 m²/g. Suitable salts are barium sulfate, barium carbonate and calcium carbonate of suitable particle sizes. Other substrates include diatomaceous earth, activated alumna, activated carbon and others. The inorganic salts are especially preferred, because they provide improved stability. It is preferred that such substrates be added to the catalyst paste.

When the dental practitioner is ready to make the impression material, he or she depresses the actuator button or lever of the dispensing device. This base and catalysts pastes are ejected from the aerosol containers and fed into the dispensing tip as discussed above. The base and catalyst pastes are mixed together in a predetermined volume ratio, preferably in a 1:1 volume ratio, to form a mixed composition. As the base and catalysts pastes are ejected through the static mixer in the dispensing tip, the vinylorganopolysiloxanes undergo addition polymerization. The mixed pastes are dispensed into an impression tray, where they start to polymerize and harden. The viscosity of the mixed pastes gradually increases. In general, for a regular set impression material, the composition is hardened within about two (2) to about five (5) minutes from the time when the components are first mixed together. While, for a fast set impression material, the composition is hardened within about one (1) to about three (3) minutes from mixing.

It is important that the dental impression material has good flow and handling properties so that an accurate recording of a patient's teeth and surrounding gum tissue can be made. The dental composition of this invention has such properties. The impression material spreads or wets well so that voids or bubbles are minimized. This also allows the impression material to capture fine detail of the patient's dental anatomy. In addition, the dental impression material has good flow characteristics so that the dental practitioner can work with material. Premature setting problems are avoided. Furthermore, the dental impression material has good strength so that the material can be easily separated from the mouth without tearing or distortion.

Using an aerosol delivery system for dispensing the dental composition provides many advantages. First, the aerosol delivery system is portable. The dispensing device preferably is designed to be held in the hand of the dental practitioner. He or she can use the dispensing device “chairside” immediately adjacent to where the patient is seated. In contrast, one type of dental impression delivery system commonly used today is known as a dynamic mixer. These dynamic mixers are relatively large machines that deliver the impression material in bulk. Dynamic mixers are not portable and are usually placed on a countertop, table, or other level surface. Cartridges containing the dental impression material are loaded in the dynamic mixer machine, and the impression material is dispensed from the cartridge. One problem with such conventional systems is that the practitioner must fill the impression tray at a countertop or other stable surface adjacent to the mixer machine. In some instances, the machine is located in a different operatory room from where the patient is located, and the practitioner must go back and forth between rooms. With the aerosol delivery system of the present invention, the practitioner can easily carry and hold the dispensing device. The time required for treating patients could be reduced using this system. Efficiency in treating patients is improved.

Secondly, the dental practitioner can accurately control the dosage being dispensed from the aerosol delivery system. By pressing the actuator button or lever, the practitioner can dispense the composition in a precisely controlled manner. When the practitioner releases his or her finger from the actuator button, the valve member moves to a closed position and there is no further dispensing of the composition. In contrast, it can be difficult to dispense compositions accurately using the above-described conventional dental cartridges and manually-operated dispensing guns. With such guns, the practitioner must squeeze the handle repeatedly to dispense the impression material into the tray. This squeezing motion makes it difficult to control the movement of the dispensing tip. Keeping the dispensing tip stationary is important, because it helps minimize formation of bubbles and voids in the impression material.

Thirdly, the dispensing device provides mechanical advantages and ergonomic benefits, because the practitioner does not need to apply excessive force to the actuator button. Rather, the practitioner can simply and easily depress the actuator button to deliver the impression material.

It is understood that the aerosol dispensing devices and dental composition described and illustrated herein represent only some embodiments of the invention. It is appreciated by those skilled in the art that various changes and additions can be made to such dispensing devices and compositions without departing from the spirit and scope of this invention.

What is claimed is:

1. An aerosol delivery device for dispensing a two-component dental composition, comprising:
a. an inner container assembly including,
i. a first chamber for storing a first component of the composition, the first chamber having a proximate opening for receiving a first piston member and a first exit port for discharging the first component; and
ii. a second chamber for storing a second component of the composition, the second chamber having a proximate opening for receiving a second piston member and a second exit port for discharging the second component;
b. a piston assembly including,
i. a first inner piston member being adapted for sliding within the first chamber;
ii. a second piston member being adapted for sliding within the second chamber;
iii. a joining member for connecting the first and second pistons of said piston assembly, so that the piston assembly slides as an integrated unit, the first piston sliding in the first chamber to force the first component through the first exit port and the second piston sliding in the second chamber to force the second component through the second exit port and into the common manifold chamber; and
iv. a barrier for separating the components from an aerosol propellant;
c. an aerosol propellant that is isolated from said components by the piston assembly;
d. an outer container that contains said inner container assembly, piston assembly and aerosol propellant;
e. a common manifold chamber that connects a dispensing tip and the inner container assembly;
f. a depressible actuator connected to a first valve assembly for controlling the flow of first component and a second valve assembly for controlling the flow of second component; and
g. a dispensing tip attached to the common manifold chamber for discharging the composition.

2. An aerosol delivery device for dispensing a two-component dental composition, comprising:
a. an inner container assembly including,
i. a first elongated cylindrically shaped chamber for storing a first component of the composition, the cylindrical chamber having inner and outer wall surfaces, a proximate opening for receiving a first piston member and a first exit port for discharging the first component; and
ii. a second elongated concentric chamber for storing a second component of the composition, the second concentric chamber having a donut-shaped cross section, the second chamber having having an inner wall surface and an outer wall surface, said second chamber having an axis that is coincident to the axis of the first cylindrical chamber, said second chamber surrounding the first cylindrical chamber in a concentric manner wherein, the outer wall surface of the first cylindrical chamber forms the first inner concentric wall surface of the second chamber, said concentric chamber having a proximate opening for receiving a donut-shaped piston member and a second exit port for discharging the second component;
b. a piston assembly including,
i. a first disc-shaped piston member being adapted for sliding within the first cylindrical chamber, said first piston having a forward-facing portion for forcing the first component into the first exit port and an opposing rear-facing portion;
ii. a second donut-shaped piston member being adapted for sliding within the second concentric chamber, said piston having a forward-facing portion for forcing the second component into the second exit port and an opposing rear-facing portion;
iii. a joining member for the first circular piston and the second donut-shaped piston of said inner container assembly, so that the piston assembly slides as an integrated unit, the first piston sliding in the first chamber to force the first component through the first exit port and the second piston sliding in the second chamber to force the second component through the second exit port and into the common manifold chamber; and
iv. a barrier for separating the components from an aerosol propellant;
c. an aerosol propellant that is isolated from said components by the piston assembly;
d. an outer container that contains said inner container assembly, piston assembly and aerosol propellant;
e. a common manifold chamber including a valve assembly;
f. a depressible actuator connected to the valve assembly for activating the assembly; and;
g. a dispensing tip attached to the common manifold chamber for discharging the composition.

3. An aerosol delivery device for dispensing a two-component dental composition, comprising:
a. an inner container assembly including,
i. a first elongated cylindrically shaped chamber for storing a first component of the composition, the cylindrical chamber having inner and outer wall surfaces, a proximate opening for receiving a first piston member and a first exit port for discharging the first component; and
ii. a second elongated chamber for storing a second component of the composition, the second chamber having a donut-shaped cross section, the second chamber having an inner wall surface and an outer concentric wall surface, said second chamber having an axis that is coincident to the axis of the first cylindrical chamber, said second chamber surrounding the first cylindrical chamber in a concentric manner wherein, the outer wall surface of the first cylindrical chamber forms the first inner concentric wall surface of the second chamber, said concentric chamber having a proximate opening for receiving a donut-shaped piston member and a second exit port for discharging the second component;
b. a piston and plunger assembly including,
i. a first disc-shaped piston member being adapted for sliding within the first cylindrical chamber, said first piston and having a forward-facing portion for forcing the first component into the first exit port and an opposing rear-facing portion;
ii. a second donut-shaped piston member being adapted for sliding within the second concentric chamber, said piston having a forward-facing portion for forcing the second component into the second exit port and an opposing rear-facing portion;
iii. a first plunger that acts upon the rear-facing portion of the disc-shaped piston;
iv. a second plunger that acts upon the rear-facing portion of the donut-shaped piston; and
v. a means for causing the simultaneous and synchronous displacement of the first and second plungers of said inner container assembly, so that the piston assembly slides as an integrated unit, the first piston sliding in the first chamber to force the first component through the first exit port and the second piston sliding in the second chamber to force the second component through the second exit port and into the common manifold chamber; and
vi. a barrier between said components and an aerosol propellant;
c. an aerosol propellant that is isolated from said components by the pistons and piston assembly;
d. an outer container that contains said inner container assembly, piston and plunger assembly and aerosol propellant;
e. a common manifold chamber including a valve assembly;
f. a depressible actuator connected to the valve assembly for activating the assembly; and
g. a dispensing tip attached to the common manifold chamber for discharging the composition.

4. The aerosol delivery device of claim 1, wherein the first and second chambers are arranged in parallel and adjacent to each other.

5. The aerosol delivery device of claim 4, wherein the first and second chambers are cylindrically shaped.

6. The aerosol delivery device of claim 4, wherein the first and second chambers are semi-circular shaped.

7. The aerosol delivery device of claim 4, wherein the first and second chambers are oval shaped.

8. The aerosol delivery system of claim 4, wherein there are multiple chambers, each of said chambers being pie-shaped.

9. The aerosol delivery system of claim 4, wherein the chambers are of substantially the same size resulting in the components being mixed in a volume ratio of about 1:1.

10. The aerosol delivery device of claim 4, wherein the chambers are of different size resulting in the components being mixed in a volume ratio other than 1:1.

11. The aerosol delivery device of claim 1, wherein one component of the dental composition is a base paste and the other component is a catalyst paste.

12. The aerosol delivery device of claim 11, wherein the base paste comprises polymerizable compound, cross-linking agent, surfactant, and filler material.

13. The aerosol delivery device of claim 12, wherein the polymerizable compound is a vinylorganopolysiloxane.

14. The aerosol delivery device of claim 12, wherein the surfactant has a hydrophobic liphophilic balance (HLB) in the range of about 8 to about 11.

15. The aerosol delivery device of claim 11, wherein the catalyst paste comprises polymerizable compound, catalyst, polymerization inhibitor, and filler material.

16. The aerosol delivery device of claim 15, wherein the polymerizable compound is a vinylorganopolysiloxane.

17. The aerosol delivery device of claim 15, wherein the catalyst is a platinum compound.

18. The aerosol delivery device of claim 15, wherein the polymerization inhibitor is 1,3 divinyltetramethyldisiloxane.
